(19) United States
(12) Patent Application Publication
(10) Pub. No.: US 2018/0333736 A1
(43) Pub. Date: Nov. 22, 2018

(54) VACUUM CLEANER ACCESSORY TOOL CONFIGURED TO DISTRIBUTE MIST

(71) Applicant: BISSELL Homecare, Inc., Grand Rapids, MI (US)

(72) Inventor: Alan J. Krebs, Pierson, MI (US)

(21) Appl. No.: 15/970,372

(22) Filed: May 3, 2018

Related U.S. Application Data
(60) Provisional application No. 62/506,666, filed on May 16, 2017.

(51) Int. Cl. B05B 17/00; A47L 5/36; A47L 9/08

(52) U.S. Cl. CPC B05B 17/0646; A47L 9/08; A47L 5/365

(57) ABSTRACT

An accessory tool for use with a vacuum cleaner. The accessory tool has a fluid delivery system configured to distribute nebulized mist onto various surfaces to be cleaned, including soft surfaces such as upholstery, dog beds, pillows, and automobile interiors. The mist can contain a solution or combination of solutions, such as an odor eliminator, a sanitizer, a stain remover, a deodorizer, a fragrance, or any combination thereof.

### CROSS REFERENCE TO RELATED APPLICATION(S)

This application claims the benefit of U.S. Provisional Patent Application No. 62/506,666, filed May 16, 2017, which is incorporated herein by reference in its entirety.

### BACKGROUND

Vacuum cleaners are known for removing dry or wet debris from surfaces, including fabric-covered surfaces like carpets and upholstery, and bare surfaces like hardwood, linoleum and tile, and contain a suction source for generating a vacuum force at the surface to remove debris. Conventional “dry” vacuum cleaners are not capable of distributing or recovering fluids from surfaces because moisture can damage the motor and filtration system of the vacuum cleaner. Separate “wet” vacuum cleaners such as vacuum mops, extractors and carpet cleaners are often used to distribute and/or remove liquids from surfaces requiring a consumer to keep several pieces of equipment available to complete different floor cleaning needs.

### BRIEF DESCRIPTION

An aspect of the present disclosure relates a vacuum accessory tool including a housing having a suction nozzle and defining an interior, a suction nozzle inlet formed in the suction nozzle and adapted to be connected to a suction source remote from the housing for generating a working air flow through the interior of the housing, a working air conduit provided on the housing in fluid communication with the suction nozzle inlet via the interior, wherein the working air conduit is adapted to be connected to a vacuum cleaner to connect the suction nozzle inlet to the suction source remote from the housing, a supply tank including a reservoir for a cleaning solution having an inlet and an outlet, and a mist delivery system including a wick defining a fluid conduit and coupled with the reservoir outlet, a mist distributor having micro-perforations and coupled to the wick, a mist generator coupled to the mist distributor including a piezoelectric transducer to generate atomized liquid mist, and wherein the piezoelectric transducer vibrates the mist distributor and cleaning solution is drawn through the fluid conduit from the reservoir outlet and is atomized into mist that can be distributed from the mist distributor onto a surface to be cleaned.

Another aspect of the present disclosure relates to a vacuum accessory tool, including a housing having a suction nozzle and defining an interior, a suction nozzle inlet formed in the suction nozzle and adapted to be connected to a suction source remote from the housing for generating a working air flow through the interior of the housing, a supply tank including a reservoir adapted to contain a cleaning solution, the supply tank having a supply tank inlet and a supply tank outlet, and a mist delivery system, comprising a fluid conduit fluidly coupled with the supply tank outlet and a mist generator operably coupled with the fluid conduit and wherein during operation of the mist delivery system the cleaning solution is drawn through the fluid conduit from the supply tank outlet to the mist generator where cleaning solution is atomized into mist and configured to be applied onto a surface to be cleaned.

### BRIEF DESCRIPTION OF THE DRAWINGS

In the drawings:

FIG. 1 is a perspective view of a vacuum cleaner accessory tool operably coupled with a vacuum cleaner according to various aspects described herein.

FIG. 2 is a perspective view of a vacuum cleaner accessory tool of FIG. 1.

FIG. 3 is a cross-sectional view along line FIG. 2.

FIG. 4 is a partially exploded view of the accessory tool of FIG. 1.

FIG. 5 is a bottom perspective view of the accessory tool of FIG. 1.

FIG. 6 is a cross-sectional view of the accessory tool of FIG. 1, illustrating the operation of the accessory tool according to various aspects described herein.

FIG. 7 is a top perspective view of a vacuum cleaner accessory tool according to a second aspect of the present disclosure.

FIG. 8 is a partially exploded view of the accessory tool of FIG. 7.

### DETAILED DESCRIPTION

Aspects of the present disclosure generally relate to features and improvements for vacuum cleaner accessory tools. Pet hair can pose a challenge to dry and wet vacuum cleaners, as pet hair can embed in and cling to carpets and upholstery in ways that make it difficult to remove. While various accessory tools have been developed to adapt conventional dry vacuum cleaners to distribute and recover liquids many of these attachments only allow for fluid recovery, and are not provided with means for fluid distribution, and further do not address the challenges specific to homes with pets, including dogs and cats, such as eliminating odors, which can linger in carpets and upholstery.

Aspects of the present disclosure generally relate to features and improvements for vacuum cleaner accessory tools that have fluid delivery and recovery capabilities. In particular, the features and improvements relate to an improved accessory tool with mist generation and distribution. Further features and improvements relate to an improved vacuum cleaner accessory tool adapted to clean pet beds and other soft surfaces which may collect pet hair and absorb odors, including upholstery, pillows, automobile interiors, etc.

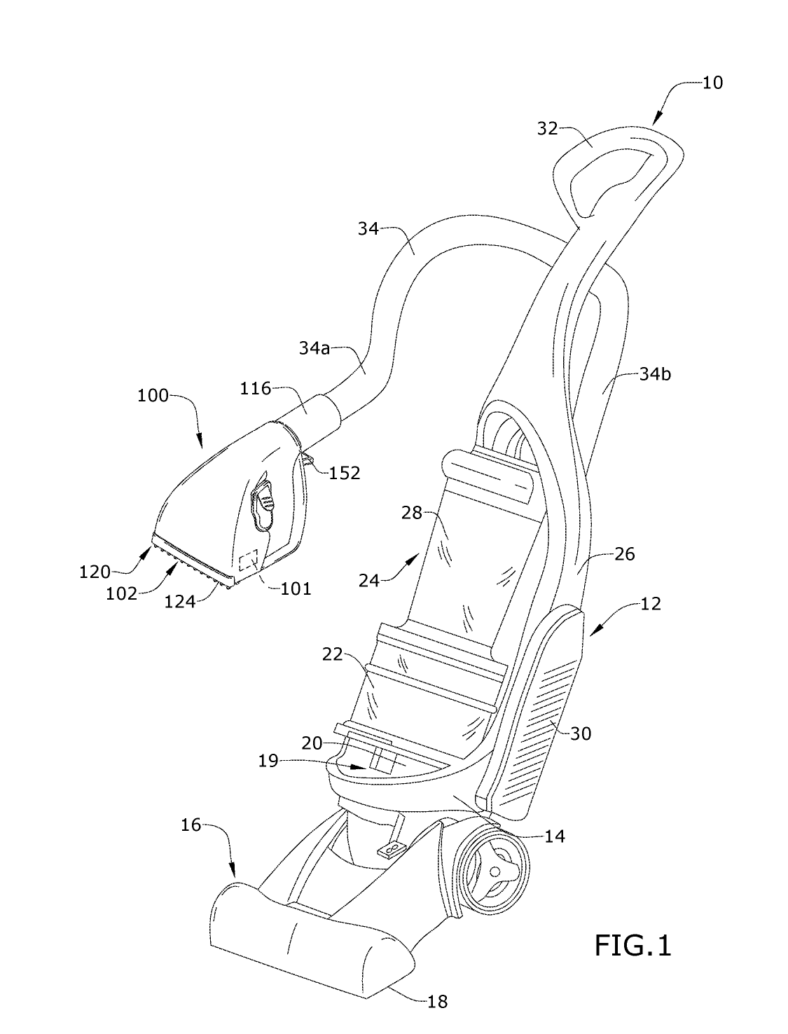

FIG. 1 is a perspective view of a first embodiment of an accessory tool 100 according to an aspect of the present disclosure operably coupled with an exemplary vacuum cleaner 10, which is shown for purposes of illustration as a “dry” vacuum cleaner 10. Details of a suitable vacuum cleaner 10 for use with the accessory tool 100 are disclosed in commonly assigned U.S. Pat. No. 6,810,557 to Hansen et al. and U.S. Pat. No. 7,188,388 to Best et al., which are incorporated herein by reference in their entirety. As used herein, the term “dry” vacuum cleaner is used to denote a vacuum cleaner that is not capable of fluid distribution or fluid recovery without the accessory tool, and may include, but is not limited to, upright, canister, stick-type, or hand-held vacuum cleaners, vacuum cleaners which are convertible between one or more of these types, or a built-in central vacuum cleaning system. As used herein, the term “wet” vacuum cleaner is used to denote a vacuum cleaner that is capable of fluid distribution (liquid or steam) and/or fluid recovery with or without the accessory tool, and may include, but are not limited to, vacuum mops, extractors and carpet cleaners, including upright, canister, stick-type, or hand-held vacuum cleaners, vacuum cleaners which are convertible between one or more of these types, or a built-in central vacuum cleaning system. Further, the vacuum cleaner used with the accessory tool(s) described herein can be adapted to clean fabric-covered surfaces, such as carpets and upholstery, or bare surfaces, such as hardwood, linoleum, and tile.

The vacuum cleaner 10 illustrated is an upright-type vacuum cleaner 10 with an upright assembly 12 pivotally mounted to a foot assembly or base 16. The upright assembly 12 further comprises a primary support section 26 with a grip 32 on one end to facilitate movement by a user. A suction source housing 19 is formed at an opposite end of the upright assembly 12 to contain a suction source 20, which may be a vacuum fan/motor assembly, and which is configured to generate a working airstream through a working air path of the vacuum cleaner 10 that extends from a “dirty” air inlet to a “clean” air outlet. The suction source 20 can form a portion of the working air path. Furthermore, the base 16 comprises a suction nozzle 18 that is in fluid communication with the suction source 20.

The primary support 26 section receives a separating and collection assembly 24 for separating debris and other contaminants from the working airstream. The separating and collection assembly 24 is illustrated herein as comprising a cyclone module having a cyclone separator 28 for separating fluid and entrained debris from the working airstream and a collection chamber 22 for collecting the separated debris. The cyclone separator 28 can have a single cyclonic separation stage, or multiple stages. It is understood that other types of dirt separating and collection assemblies can be used, such as centrifugal separators or bulk separators. In yet another conventional arrangement, the filtration system can comprise a filter bag. Regardless of its particular configuration, the filtration system can form a portion of the working air path through the vacuum cleaner 10. Additional filters may be provided in the filtration system, including pre- and post-motor filters.

At least a portion of the working air path leading to the separating and collection assembly 24 can be formed by a vacuum hose 34.

The accessory tool 100 includes a fluid delivery system 101 for storing a cleaning fluid and delivering the cleaning fluid to a surface to be cleaned, and a fluid recovery system 102 for removing the spent cleaning fluid and dirt from the surface to be cleaned and storing the spent cleaning fluid and dirt. The accessory tool 100 is configured to be operably coupled with the vacuum cleaner 10 having a source of suction 20, and can in particular be coupled with the vacuum hose 34 in fluid communication with the suction source 20 carried by a housing 14 of the vacuum cleaner 10. For example, one end 34a of the vacuum hose 34 can be selectively disconnected from the vacuum cleaner 10 and connected to the accessory tool 100 for cleaning using the accessory tool 100, as shown in FIG. 1, while the other end 34b remains in fluid communication with the separating and collection assembly 24. When the accessory tool 100 is in use and the end 34a of the vacuum hose 34 is coupled with the accessory tool 100, the accessory tool 100 can form the “dirty” air inlet. Thus, the vacuum cleaner 10 can draw in dirt-laden air through the accessory tool 100 and hose 34 and into the filtration system, such as the separating and collection assembly 24, where the dirt is trapped for later disposal. When the accessory tool 100 is not in use, and both ends 34a, 34b of the vacuum hose 34 are connected with the vacuum cleaner 34, which can include the ends 34a, 34b coupled to the base 16, the suction nozzle 18 can form the “dirty” air inlet. Alternatively, the accessory tool 100 can be selectively connectable to a wand (not shown) that is coupled with the vacuum hose 34 rather than directly to the vacuum hose 34.

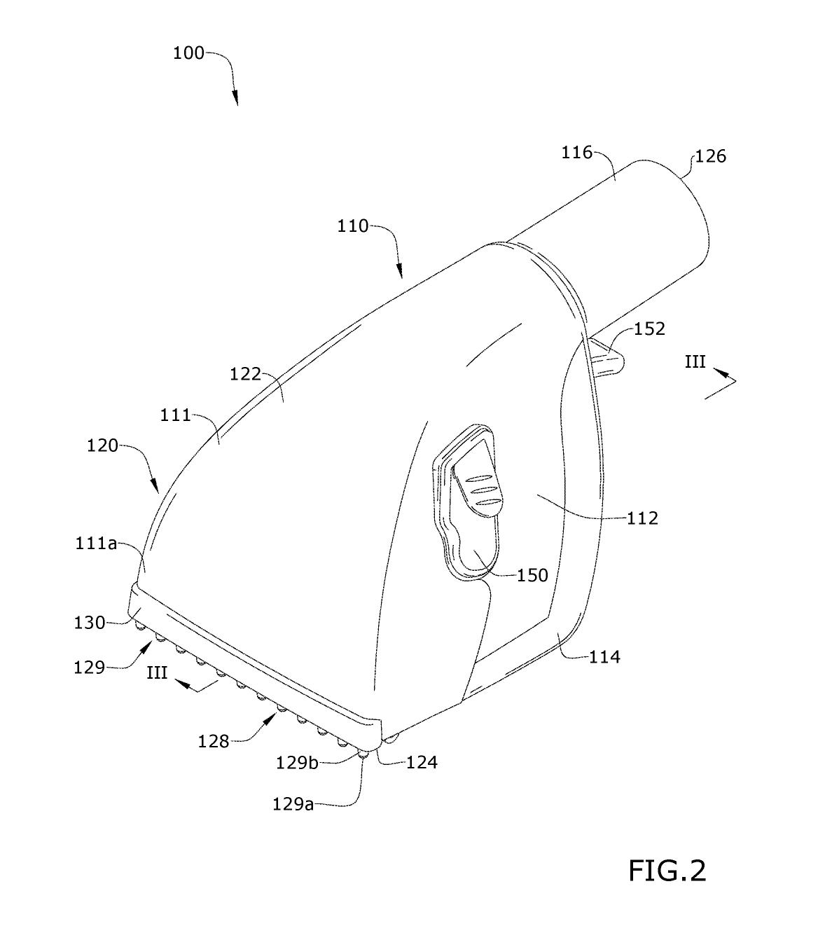

FIG. 2 illustrates the accessory tool 100 in more detail. A main housing 110 of the accessory tool is collectively formed by an upper housing 112 and a lower housing 114, a suction nozzle 120 is formed at a forward portion 111 of the main housing 110. It will be understood that while the accessory tool 100 is shown as having a two-part main housing 110, the accessory tool 100 can have a single main housing, or a multi-piece main housing that is secured together.

A handle 116 can be integral with the main housing 110. The handle 116 can include a body for a user to hold, or grip, the accessory tool 100. The handle 116 can include an outlet 126. The handle 116 can be configured to be operably coupled with the vacuum hose 34 on the vacuum cleaner 10 (FIG. 1) such that a fluid coupling can be created via the outlet 126. Additionally, a trigger 152 can conveniently be located on the accessory tool 100 for single-handed operation of the accessory tool 100.

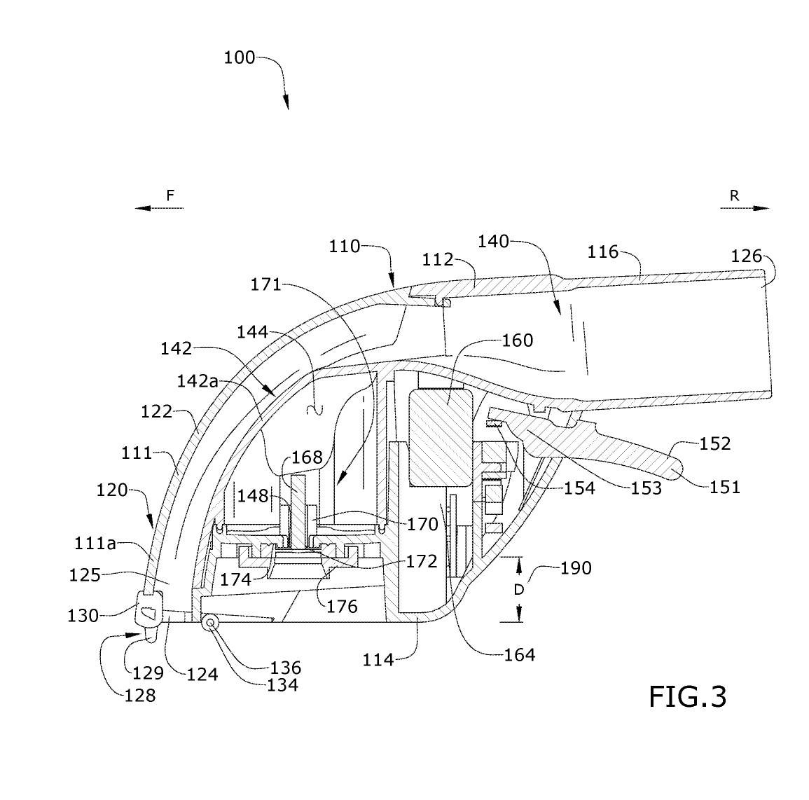

The suction nozzle 120 can be defined by a nozzle cover 122 and can include suction nozzle inlet 124. The suction nozzle inlet 124 can be narrow, such as about 76.2 millimeters to 101.6 millimeters (three to four inches) wide, and 12.7 millimeters to 19.05 millimeters (½ to ¾ inches) deep, for example, to generate high velocity airflow into the accessory tool 100. When the accessory tool 100 is coupled with the vacuum cleaner 10, the suction nozzle inlet 124 of the accessory tool 100 can form the “dirty” air inlet. A working airflow can be drawn through an airflow pathway 140 (FIG. 3) of the accessory tool 100 defined in the main housing 110 from the nozzle inlet 124 to the outlet 126.

An agitator 128 can be mounted to a front edge 111a of the forward portion 111 of the suction nozzle 120. The agitator 128 can include a plurality of elastomeric nubs 129 for removing hair from the surface to be cleaned. In some aspects, the agitator 128 can comprise a plurality of bristles. Bristles are often bundled together to generate adequate strength for agitation. The nubs 129 are distinguished from bristles in being shorter than bristles, having a larger diameter than bristles, and being stiffer than bristles. By way of non-limiting example, a tip 129a that does not flex substantially relative to an upper end 129b is illustrated as being included in the nub 129. The tip 129a of the nubs 129 can be rounded. The nubs 129 can be arranged in a single row in front of the suction nozzle inlet 124. The nubs 129 can be integrally molded with a bumper 130 that can be mounted on the front of the suction nozzle 120 of the accessory tool 100. In one example, the agitator 128 is molded into a lower front edge 111a of the nozzle cover 122. Some examples of suitable elastomeric materials for the nubs 129 include thermoplastic polyurethane (TPU), thermoplastic elastomer (TPE), and silicone.

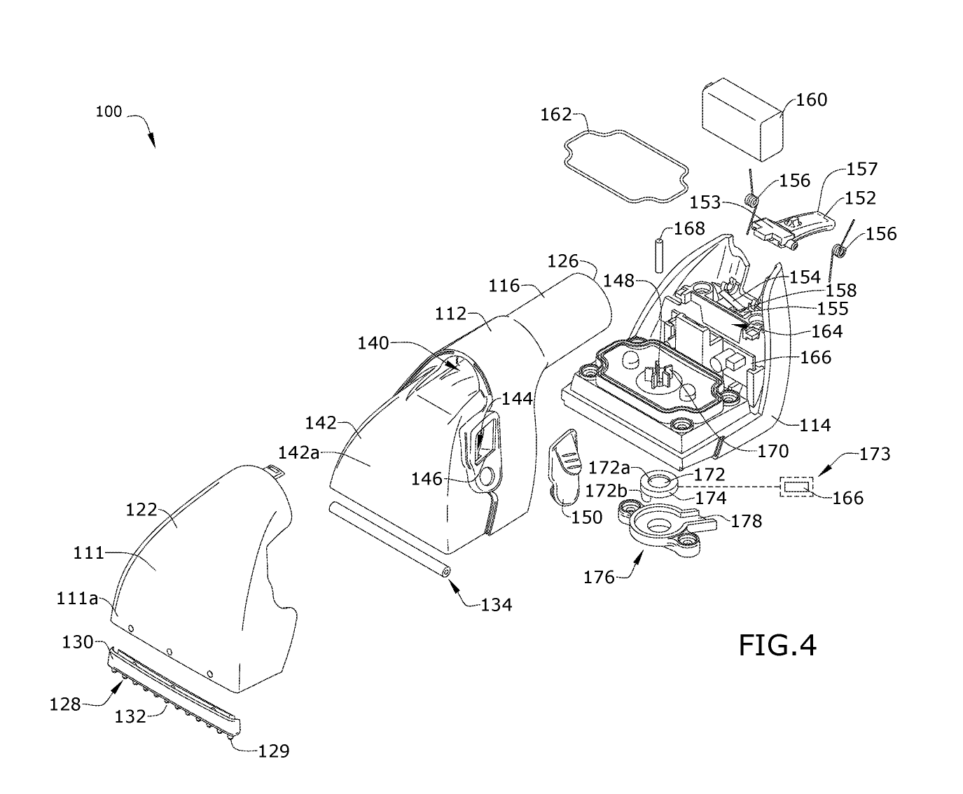

FIG. 3 illustrates a cross-sectional view along line in FIG. 2 and FIG. 4 illustrates a partially exploded view of the accessory tool 100. Referring to FIGS. 3 and 4, the accessory tool further 100 includes a supply tank 142 defining a reservoir 144 for storing a cleaning solution, which can be in liquid form. The supply tank 142 can be integrally formed with the main housing 110 such that the supply tank 142 is not removable from the main housing 110. For example, the supply tank 142 can be formed by the upper housing 112, which can form the top and sides of the supply tank 142 including a reservoir inlet 146 (FIG. 4) that can be coupled with the tank fill cap 150, while the lower housing 114 can form the bottom of the supply tank 142 including a reservoir outlet 148. A seal 162 (FIG. 4) can be provided for sealing the interface between the portions formed by the upper housing 112 and the lower housing 114 that form the reservoir 144. The supply tank 142 can be spaced rearward from the nozzle cover 122.

The reservoir inlet 146 for filling the reservoir can be covered by the openable closure, or tank fill cap 150 (FIG. 2). The tank fill cap 150 can be in the form of a resilient fill cap that plugs the fill opening. The tank fill cap 150 can be tethered to the main housing 110 so that the upper end of the tank fill cap 150 can be pulled out of the reservoir inlet 146 to expose the reservoir inlet 146 for refilling the reservoir 144 with cleaning solution. Other configurations of closures are possible, including, but not limited to, a threaded cap screwed onto the reservoir inlet.

The cleaning solution stored in the reservoir 144 may be water or a mixture including water and one or more treating agents, or one or more treating agents without water. Treating agents can include, but are not limited to, odor eliminators, sanitizers, stain removers, odor removers, deodorizers, fragrances, or any combination thereof. For example, the solution can include an odor eliminator (e.g. Febreze®), a combination including a sanitizer, a stain remover, and an odor remover (e.g. BISSELL® Pet Pretreat & Sanitize Stain & Odor Remover for Carpet, Model 1129 or Woolite® Advanced Pet Stain & Odor Remover, Model 11521), or a deodorizer or fragrance, for example. The solution can be configured for a particular cleaning application, such as, but not limited to, cleaning pet beds and other soft surfaces which may collect pet hair.

The airflow pathway 140 can be configured such that air can flow in a rearward direction from the suction nozzle inlet 124, as indicated by arrow R. The airflow pathway 140 can be at least partially defined by a conduit that can form the handle 116 for holding the accessory tool 100. In the illustrated embodiment, the suction nozzle 120 can be further defined by a front wall 142a of the supply tank 142. The space between the nozzle cover 122 and the supply tank 142 can form a suction nozzle passage 125 which extends from the suction nozzle inlet 124 to the conduit forming the handle 116. The suction nozzle passage 125 can form part of the working airflow pathway 140 through the accessory tool 100.

In one non-limiting example, the fluid delivery system 101 (FIG. 1) comprises a mist delivery system for generating a nebulized mist from the cleaning solution stored in the reservoir 144. The mist delivery system can include a mist generator 171 for generating the nebulized mist and a mist distributor 172 for delivering the nebulized mist to the surface to be cleaned. The nebulized mist is a fine or atomized spray of cleaning solution. It is noted that, unlike conventional steam generators, the mist delivery system nebulizes the cleaning solution to produce a mist and does not heat the cleaning solution to a high temperature to produce steam.

Referring to FIG. 3, the mist distributor 172 can be provided at a bottom side of the lower housing 114, rearward of the suction nozzle inlet 124 and elevated or offset above the suction nozzle inlet 124 and surface to be cleaned by a distance D 190. For example, the mist distributor 172 can be elevated or offset above the suction nozzle inlet 124 and surface to be cleaned by about 0.50 inches (about 12.7 mm). Spacing the mist distributor 172 from the suction nozzle 120 can prevent the formation of condensation on the nozzle cover 122.

The mist generator 171 can include a piezoelectric transducer 174 for generating a finely atomized liquid mist. Referring to FIG. 4, the piezoelectric transducer 174 can include a ring-shaped or annular piezoelectric element surrounding the mist distributor 172 and can be adapted to convert signals received from an electronic controller 173 into mechanical vibrations. The electronic controller 173 can include a printed circuit board (PCB) 166 configured to provide output signals to the piezoelectric transducer 174. The piezoelectric element can be adapted to vibrate within a frequency range of 5.0 kHz-2.5 MHz and preferably at 1.7 MHz to convert low viscosity liquid into fine mist particles with diameters ranging from 10 microns (μ) to 100 microns (μ).

In one example, the piezoelectric transducer 174 can include an outer diameter of 20 mm and an inner diameter of 12 mm and can be mounted to the mist distributor 172, which can be in the form of a micro-perforated metal, such as a mesh, disk provided at the open area of the inner diameter of the annular transducer 174.

FIG. 3 illustrates that a wick 168 is provided at the reservoir outlet 148 that is in register with the mist generator 171. The wick 168 can define a fluid conduit configured to transfer cleaning solution from the reservoir 144 to the mist generator 172, and can more specifically comprise an absorbent material for transferring cleaning solution from the reservoir 144 to the mist generator 171 by capillary action. Some examples of suitable wick materials include felt, porous thermoplastic material such as polyethylene (PE), or synthetic thermoplastic polymer fibers such as polyethylene/polyester (PE/PET) fiber. Because the wick 168 transfers cleaning solution by capillary action, cleaning solution can be transferred to the mist generator 171 regardless of the orientation of the accessory tool 100, even when the accessory tool 100 is inverted with the reservoir 144 oriented below the mist generator 171, for example.

The wick 168 can be mounted in various ways; in the example shown herein, a wick mount comprising a plurality of vertical fins 170 can be provided around the reservoir outlet 148. The fins 170 are configured to retain a wick 168 having a cylindrical shape at the reservoir outlet 148. The spacing between the fins allows cleaning solution to enter the wick from the sides, as well as from the top.

The wick 168 can be press-fit into the cylindrical opening formed by the vertical fins 170 around the reservoir outlet 148 opening. The base of the wick 168 protrudes through the reservoir outlet 148 at the bottom of the reservoir and is in register with the metal disk. Thus, the wick 168 is fluidly connected to the mist distributor 172, and the wick 168 transfers cleaning solution to a first upper face 172a of the mist distributor 172.

The piezoelectric transducer 174 is configured to vibrate the mesh such that cleaning solution is drawn through the perforations from the first upper face 172a fluidly connected to the reservoir 144 by the wick 168, through a second face 172b of the mist distributor 172 which faces toward the outside of the main housing 110, where cleaning solution can be distributed as a nebulized mist onto the surface to be cleaned. The portion of mesh within the inner diameter of the piezoelectric transducer 174 is exposed and defines the outlet of the mist distributor 172. The diameter of each perforation is small enough such that cleaning solution does not pass through the perforations due to surface tension of the cleaning solution, unless the piezoelectric transducer 174 is energized. In one example, the diameter of each perforation is about 4-11 microns. In another example, not shown, the piezoelectric transducer 174 can use a horizontal distributor which vibrates to generate mist. Liquid over the horizontal distributor atomizes and is propelled upward. In this case, an auxiliary fan may be provided to move the atomized liquid out of the tool.

The piezoelectric transducer 174 is operably connected to the electronic controller 173, which is connected to a power source via the conductor wires (not shown) and a power switch 154. The power source can be a battery 160, which makes the accessory tool 100 convenient for use with a wide-range of vacuum cleaners. Alternatively, the power source can comprise any other suitable power source, such as the power source of the vacuum cleaner itself, in which case the accessory tool 100 can be provided with an electrical connector for coupling with a compatible electrical connector of the vacuum cleaner. The battery 160 can be received in a battery mount 164 on the main housing 110, and the battery mount 164 can be accessible to the user to periodically replace or recharge the battery 160.

In an alternate embodiment, the power source for the accessory tool 100 can comprise a rechargeable battery or line power source and the switch 154 can comprise a single pole, single throw switch, which would energize the piezoelectric transducer 174 continuously whenever the switch 154 is moved to the “on” position. The switch 154 may be moved to the “on” position by the trigger 152, as shown in the illustrated embodiment such that the trigger 152 is configured to provide a user interface to control the mist delivery system.

The power switch 154, which can be in the form of a momentary switch that is operably connected to the trigger 152 for selectively actuating the switch 154 to distribute mist intermittently. A switch mount 155 can be provided for mounting the switch 154 in operable engagement with the trigger 152. The trigger 152 can be located beneath the handle 116, such that a user gripping the accessory tool 100 by the handle 116 using one hand can also use the trigger finger on that same hand to squeeze the trigger 152 upwardly toward the handle 116. The trigger 152 can be pivotally mounted to the main housing, with one end adapted be engaged by the user, and another end adapted to selectively actuate the switch 154. A user-engageable end 151 can be exterior of the main housing 110, and a switch-engaging end 153 can be interior of the main housing 110. One or more springs 156 (FIG. 4) can bias the trigger 152 away from engagement with the switch 154.

An elongate roller 134 can be mounted transversely to the lower housing 114 rearward of the suction nozzle inlet and can form a barrier between the suction nozzle inlet 124 and the mist generator 171. The roller 134 is configured to rotate about a central axle 136 while an outer surface of the roller 134 rollably contacts the surface to be cleaned. The roller 134 can block a majority of the mist from flowing directly into the suction nozzle inlet 124 from the mist distributor 172 during use. Thus, the exposure between the mist and the surface being cleaned is maximized for increased efficacy and performance.

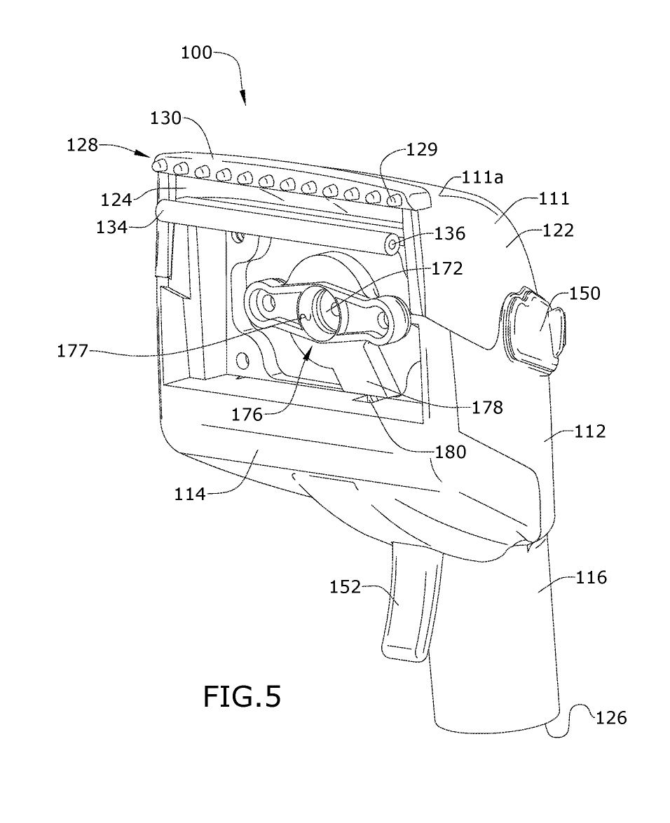

As best seen in FIG. 5, a mounting plate 176 can hold the piezoelectric transducer 174 in place on the main housing 110. The mounting plate 176 includes a space for receiving the piezoelectric transducer 174 which includes an opening 177 at a lower side thereof for the passage of mist. The opening 177 can be funnel-shaped, and can be wider at the lower end than the top end to encourage the diffusion of the mist. The mounting plate 176 can further include a wiring conduit 178 which opens to the space for passage of conductor wires (not shown) from the PCB 166 (FIG. 4) to operably connect the piezoelectric transducer 174. A wiring slot 180 is provided in the lower housing 114 for the passage of wiring from the battery 160 to the piezoelectric transducer 174.

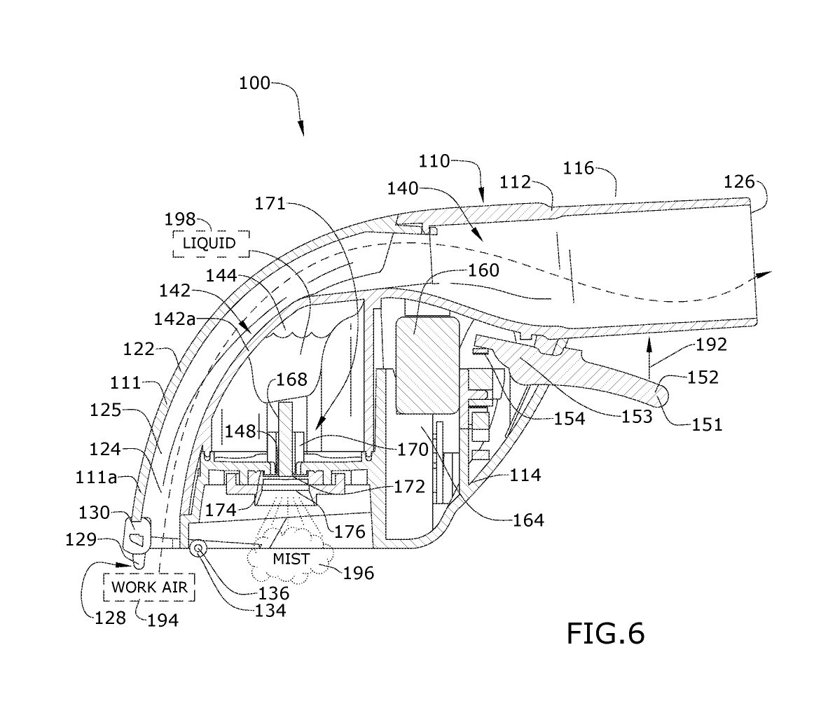

With reference to FIG. 6, in operation, a user can fill the supply tank 142 with a desired liquid by removing the fill cap 150 from the reservoir inlet 146 (FIG. 4) and pouring cleaning solution 198 into the reservoir 144. Next, a user can fluidly connect the outlet 126 to the vacuum cleaner 10, such as via the vacuum hose 34, as shown in FIG. 1, or via a wand, and energize the suction source 20 of the vacuum cleaner 10 to draw a working air flow 194 through the accessory tool 100. A user can operate the accessory tool 100 like a conventional suction accessory tool by stroking the accessory tool 100 over the surface to be cleaned to remove debris therefrom. However, if the user desires to further treat a surface to be cleaned with a solution, the user can selectively actuate the trigger 152 to generate and distribute mist 196 onto the surface to be cleaned. The trigger 152 can actuate the power switch 154 and the controller 173 can energize the piezoelectric transducer 174. The piezoelectric transducer 174 can vibrate the mist distributor 172. Liquid from within the reservoir 144 can be drawn through the perforations and atomized into a fine mist, which is distributed from the second face of the mist distributor 172, beneath the lower housing 112. The mist 196 can be distributed from the mist distributor 172 onto the surface to be cleaned to sanitize, deodorize, and/or clean or otherwise treat the surface to be cleaned.

Releasing the trigger 152 can stop the distribution of mist. A user can clean the surface to be cleaned before or after releasing the trigger 152 since debris on the surface are able to be drawn into the suction nozzle passage 125 and the airflow pathway 140 whether or not the debris are wet or dry. In one example, a user can actuate the trigger 152 by pulling the trigger 152 towards the main housing 110 to distribute mist 196 to the surface to be cleaned and simultaneously clean the surface. In another example, a user can actuate the trigger 152 to distribute mist 196 to the surface to be cleaned and then release the trigger 152 and clean the surface. Cleaning the surface can include stroking the surface with the agitator 128 such that the nubs 129 can agitate the surface to loosen debris. The loosened debris is then able to be drawn into the suction nozzle passage 125.

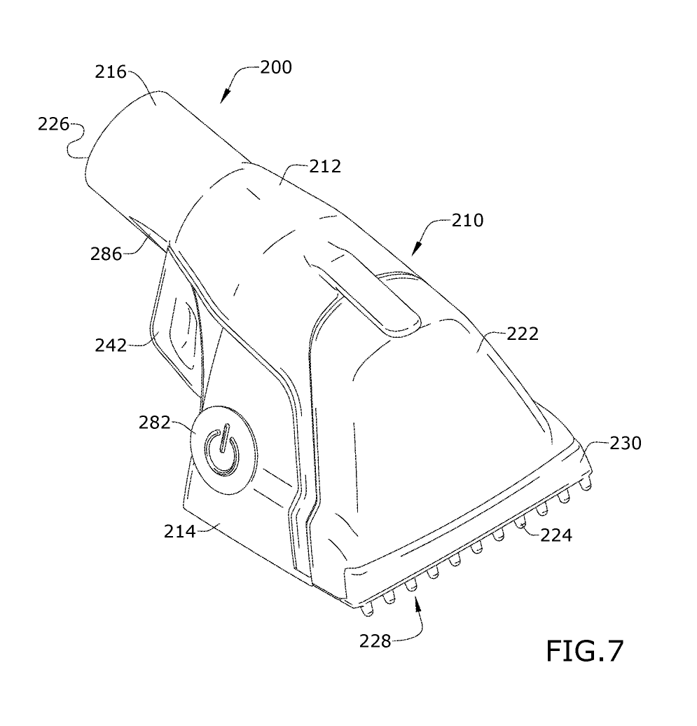

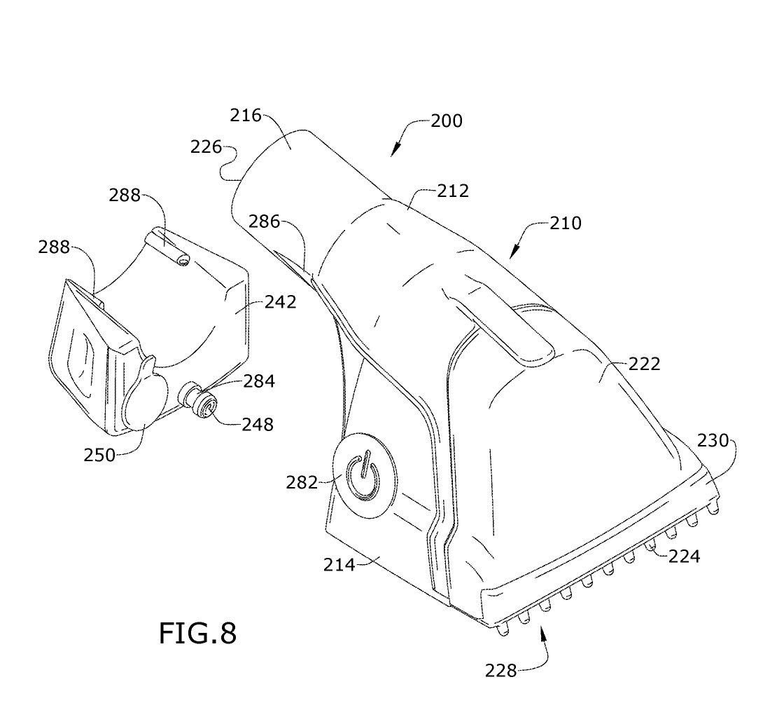

Referring to FIGS. 7-8, an accessory tool 200 according to another aspect of the present disclosure is illustrated, and comprises the same components as described for the accessory tool 100, save for the supply tank and power switch. Therefore, like parts will be identified with like numerals increased by 100, with it being understood that the description of the like parts applies to the accessory tool 200, unless otherwise noted. One difference is that the accessory tool 200 includes a supply tank 242 that is a separate tank and can be removably coupled with the main housing 210. The reservoir inlet (not shown) can be covered by an openable closure, such as a resilient fill cap 250. The reservoir outlet 248 is defined by a fluid connector 284 that plugs into the mist delivery system when the supply tank 242 is received on the main housing 210. The supply tank 242 can be removably retained on the main housing 210 by rails 288 on the supply tank 242 that are received in tracks 286 on the underside of the handle 216, although other structures for removably mounting the supply tank 242 are also possible.

The accessory tool 200 can include a power switch (not shown) to operably connected to a push button 282 for selectively actuating the switch to distribute mist intermittently. The push button 282 can be located on the side of the main housing 210. The push button 282 can be pressed once to actuate the mist delivery system, which can remain on until the push button 282 is pressed again. This may be more convenient in some cases than the trigger 152 of the accessory tool 100, which can be continuously held to dispense mist.

There are several advantages of the present disclosure arising from the various features of the apparatus described herein. For example, the aspects described above provide an improved vacuum cleaner accessory tool with a fluid delivery system configured to distribute nebulized mist onto various soft surfaces to be cleaned, such as upholstery, dog beds, pillows, automobile interiors, etc. Delivering mist can be preferable to delivering liquid because adequate cleaning solution can be delivered without over-wetting the surface. Over-wetting a surface can impact drying time. With various aspects described herein, the surface is dry and usable again almost immediately after cleaning. Using mist also allows the accessory tool to be used with “dry” vacuum cleaners and other surface cleaning apparatus that are not configured to collect liquid.

Another advantage arising from the various features of the apparatus described herein is that the aspects described above provide an accessory tool configured to distribute a nebulized mist that can contain a solution or combination of solutions, such as an odor eliminator (e.g. Febreze®), a combination including a sanitizer, a stain remover, and an odor remover (e.g. BISSELL® Pet Pretreat & Sanitize Stain & Odor Remover for Carpet, Model 1129 or Woolite® Advanced Pet Stain & Odor Remover, Model 11521), or a deodorizer or fragrance, for example.

Yet another advantage arising from the various features of the apparatus described herein is that the accessory tool can be used with “dry” vacuum cleaners and other surface cleaning apparatus that are not configured to collect liquid. By providing a rolling barrier between the suction nozzle inlet and the mist generator, mist is blocked from flowing directly into the suction nozzle inlet during use, while also not impeding movement of the tool over the surface to be cleaned. Furthermore, by dispensing cleaning fluid in the form of a nebulized mist, over-wetting of the surface is avoided.

While a “dry” vacuum cleaner has been illustrated herein, it is understood that any commonly known vacuum cleaner or surface cleaning appliance comprising a suction source is acceptable for use with the accessory tools described herein including an autonomous robot floor cleaner. For example, details of a suitable “wet” vacuum cleaner for use with the accessory tool are disclosed in commonly assigned U.S. Pat. No. 9,186,028 to White et al. and U.S. Pat. No. 6,279,196 to Kasen et al., which are incorporated herein by reference in their entirety. Furthermore, details of a suitable “autonomous robot floor cleaner” for use with the accessory tool are disclosed in commonly assigned U.S. patent application Ser. No. 15/705,781 to Scholten et al., which is incorporated herein by reference in its entirety.

To the extent not already described, the different features and structures of the various embodiments of the accessory tools may be used in combination with each other as desired. That one feature may not be illustrated in all of the embodiments is not meant to be construed that it cannot be, but is done for brevity of description. Thus, the various features of the different embodiments of the accessory tools may be mixed and matched as desired to form new embodiments, whether or not the new embodiments are expressly described.

While the invention has been specifically described in connection with certain specific embodiments thereof, it is to be understood that this is by way of illustration and not of limitation. Reasonable variation and modification are possible with the scope of the foregoing disclosure and drawings without departing from the spirit of the invention which, is defined in the appended claims. Hence, specific dimensions and other physical characteristics relating to the embodiments disclosed herein are not to be considered as limiting, unless the claims expressly state otherwise.

What is claimed is:

1. A vacuum accessory tool, comprising:
a housing having a suction nozzle and defining an interior;
a suction nozzle inlet formed in the suction nozzle and adapted to be connected to a suction source remote from the housing for generating a working air flow through the interior of the housing;
a supply tank including a reservoir adapted to contain a cleaning solution, the supply tank having a supply tank inlet and a supply tank outlet; and
a mist delivery system, comprising:
a wick fluidly coupled with the supply tank outlet and defining a fluid conduit;
a mist distributor operably coupled to the wick, the mist distributor having a body with having micro-perforations;
a mist generator operably coupled to the mist distributor, the mist generator includes a piezoelectric transducer; and
wherein cleaning solution is drawn through the fluid conduit from the supply tank outlet towards the mist distributor and the piezoelectric transducer vibrates the mist distributor and cleaning solution on the mist distributor is atomized into mist and configured to be applied onto a surface to be cleaned.

2. The vacuum accessory tool of claim 1 wherein the piezoelectric transducer surrounds the mist distributor.

3. The vacuum accessory tool of claim 1, further comprising a roller located between the suction nozzle inlet and the mist generator to block the mist from flowing directly into the suction nozzle inlet.

4. The vacuum accessory tool of claim 1, further comprising a controller and a power switch and wherein the piezoelectric transducer is operably connected to the controller and the power switch.

5. The vacuum accessory tool of claim 4, further comprising a trigger operably connected to the power switch and configured to provide a user interface to control the mist delivery system.

6. The vacuum accessory tool of claim 4, further comprising a push button operably connected to the power switch and configured to provide a user interface to control the mist delivery system.

7. The vacuum accessory tool of claim 1 wherein the piezoelectric transducer is adapted to vibrate within a frequency range of 5.0 kHz-2.5 MHz to convert cleaning solution into the mist.

8. The vacuum accessory tool of claim 7 wherein the piezoelectric transducer is adapted to vibrate at about 1.7 MHz.

9. The vacuum accessory tool of claim 1 wherein the mist includes diameters from about 10 microns to 100 microns.

10. The vacuum accessory tool of claim 1 wherein the piezoelectric transducer is annular and comprises an inner diameter and an outer diameter and the mist distributor is provided within the inner diameter.

11. The vacuum accessory tool of claim 10 wherein the inner diameter is about 12 mm and the outer diameter is about 20 mm.

12. The vacuum accessory tool of claim 1 wherein the wick comprises an absorbent material.

13. The vacuum accessory tool of claim 12 wherein the absorbent material is any one of a felt, a porous thermoplastic material including a polyethylene, or a synthetic thermoplastic polymer fiber including a polyethylene/polyester fiber.

14. The vacuum accessory tool of claim 1, further comprising a plurality of spaced fins operably coupled to the wick and configured to retain the wick.

15. The vacuum accessory tool of claim 1 wherein the micro perforations are in the range of 4-11 microns.

16. The vacuum accessory tool of claim 1, further comprising a mounting plate operably coupled to the housing and adapted to hold the piezoelectric transducer in place on the housing.

17. The vacuum accessory tool of claim 16 wherein the mounting plate comprises an opening for passage of the mist.

18. The vacuum accessory tool of claim 17 wherein the opening is funnel-shaped and adapted to encourage diffusion of the mist.

19. The vacuum accessory tool of claim 1 wherein the supply tank is removably coupled with the housing.

20. A vacuum accessory tool, comprising:
a housing having a suction nozzle and defining an interior;
a suction nozzle inlet formed in the suction nozzle and adapted to be connected to a suction source remote from the housing for generating a working air flow through the interior of the housing;
a supply tank including a reservoir adapted to contain a cleaning solution, the supply tank having a supply tank inlet and a supply tank outlet; and
a mist delivery system, comprising a fluid conduit fluidly coupled with the supply tank outlet and a mist generator operably coupled with the fluid conduit and wherein during operation of the mist delivery system the cleaning solution is drawn through the fluid conduit from the supply tank outlet to the mist generator where cleaning solution is atomized into mist and configured to be applied onto a surface to be cleaned.
